(19) United States
(12) Patent Application Publication
(10) Pub. No.: US 2012/0181333 A1
(43) Pub. Date: Jul. 19, 2012

(54) Secure ID Credential With Bi-State Display For Unlocking Devices

(76) Inventors: Mark Stanley Krawczewicz, Annapolis, MD (US); Kenneth Hugh Rose, Annapolis, MD (US); Jay Steinmetz, Balt, MD (US)

(21) Appl. No.: 13/330,654

(22) Filed: Dec. 19, 2011

Related U.S. Application Data
(60) Provisional application No. 61/424,383, filed on Dec. 17, 2010.

(51) Int. Cl. G06K 5/00; G06K 19/02

(52) U.S. Cl. 235/380; 235/488

(57) ABSTRACT

A secure identification card having a batteryless thin flexible display inlay and a housing encapsulating the batteryless thin flexible display inlay. The batteryless thin flexible display inlay has a bi-state display, display control circuitry, a secure processor and an antenna. The housing has a composite layer having front and back faces and a window aligned with the display in the batteryless thin flexible display inlay, printing on the front face of the composite later and a transparent polyester plastic layer encapsulating the composite layer, the printing and the window.

### CROSS-REFERENCE TO RELATED APPLICATIONS

The present application claims the benefit of the filing date of U.S. Provisional Patent Application Ser. No. 61/424,383 filed by Mark Stanley Krawczewicz and Jay Steinmetz on Dec. 17, 2010.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The present invention relates to identification badges and, more particularly, to secure identification credentials and badges used to cryptographically unlock a mobile smart phone, laptop, or access control portal or other mobile devices.

2. Brief Description of the Related Art

A variety of systems and methods for secure authentication using a token have been used in the past. Such smart tokens may be in the form of smartcards, USB tokens or other forms. Conventional smartcards typically are credit-card sized and made out of flexible plastic such as polyvinyl chloride. Smartcards have been used in wide varieties of applications, such as identification badges, membership cards, credit cards, etc. Conventional USB token are typically small and portable and may be of any shape. They are embedded with a micromodule containing a silicon integrated circuit with a memory and a microprocessor.

Traditional plastic card ID credentials rely on printed inks and tamper evident materials like holograms, printed static 2D barcodes, and passwords for security and to protect user data from modifications. To verify these traditional cards, readers employ multimodal optical and wavelength sensors in an attempt to verify a user's identity printed on the card.

Smartcards can be either “contact” or “contactless.” Contact cards typically have a visible set of gold contact pads for insertion into a card reader. Contactless cards use radio frequency signals to operate. Other smart tokens connect to other devices through a USB or other communications port.

Smart cards typically may have information or artwork printed on one or both sides of the card. Since smart cards are typically credit card sized, the amount of information that may be displayed on a smartcard is typically limited. A number of efforts have been made to increase the amount of data that may be displayed on a smartcard. For example, U.S. Pat. No. 7,270,276 discloses a multi-application smartcard having a dynamic display portion made, for example, of electronic ink. The display on that card changes from a first display to a second display in response to an application use of the smartcard. Another example is U.S. Patent Publication Serial No. US2005/0258229, which disclosed a multi-function smartcard (also known as an “integrated circuit card” or “IC card”) with the ability to display images on the obverse side of the card.

A display of images on a flexible display within a card typically implements an active pixel matrix display type display which has the ability to show 8 or more degrees of gray scale on each pixel. The two dimensional array of these gray scale pixels generate an image of a cardholder face. A segmented type flexible display has only two states (black or white). A group of seven segments will comprise any single digit number whereas a group of 14 segments will denote any alphabetic or numeric letter or digit. The display and control circuitry is much more simplistic for segmented displays than for active matrix displays. The present application addresses only segmented flexible bi-state displays for secure ID credentials.

Access control stations typically located on the boundary of the security area or building use some method to verify or authenticate the uses who are allowed access. The general methods to authenticate include one or more of the following defined as 1, 2, or 3 factor authentication:
1. What you have—a card or ID machine or visually checked by a guard
2. What you know—a password typed into a keypad
3. What you are—a physical biometric attribute comparing a pre-stored “template” to a live scan using some hardware at the access control station

There are many shortfalls and added system complexities for implementing these access control methods like; user data must be stored on a database or within the card securely, cards can be duplicated or lost, passwords can be hacked, biometrics are difficult and costly to store and scale to larger access control networks.

More recently, biometric thumb drive tokens and smartcards have proven ineffective and non-secure. These shortcomings vary but complexity, scalability, and interoperability are common causes. It was found that biometrics are challenging to enroll and deploy when the user's information is stored and retrieved on a central database.

Other shortfalls with 3-factor authentication using cards and access control portals are portability, scalability, and verification the machine-based authentication actually happened. This part of the transaction is usually completely transparent to the user and/or verifying official until the end of the process.

Recently, efforts have been made to incorporate displays into RFID cards and tags. For example, in U.S. Patent App. Pub. No. 2010/0052908 entitled “Transient State Information Display in an RFID Tag,” a display is incorporated into an RFID card to show a transient state such as an age of a product. In the preferred embodiment disclosed in that patent, a card or tag reader provides a current date while the card provides the expiration date of the product. Based on a comparison of those two, an LED is illuminated to reflect the status of the product. The disclosure indicates that a variety of other types of displays may be used and also that the card may be active or passive. In another example, U.S. Patent App. Pub. No. 2010/0079416 entitled “Radio Frequency Identification (RFID), Display Pixel, and Display Panel and Display Apparatus Using RFID Display Pixel” discloses an RFID tag connected to an “RFID pixel” or plurality of “RFID pixels.” Another example is described in U.S. Patent App. Pub. No. 2009/0309736 entitled “Multifunction Contactless Electronic Tag for Goods.”

### SUMMARY OF THE INVENTION

Confirmation of acceptance or rejection typically is signaled with an audible tone, text on a reader, a red/green light or any combination of these. What is missing is visual evidence of verification on the card side with these systems. The present application provides the capability to dynamically change the segmented display after a successful authentication with a timestamp date, title/role, or other clearly visible text that the cardholder in-fact authenticated. An official or person could later visually check the display on the cardholder ID they successful authenticated with a pin number, biometrics or presenting their card to a verification station.

With the display card system of the present invention, a cardholder does not require to have a continual chain-of-trust from the time they first entered a security portal at the boundary of a secure facility (where they were machine verified) to having their card check later (via human verification).

In a preferred embodiment, the present invention is a secure identification card. The card comprises a batteryless thin flexible display inlay and a housing encapsulating the batteryless thin flexible display inlay. The batteryless thin flexible display inlay comprises a segmented-type bi-state display, display control circuitry, a secure processor and an antenna. The housing comprises a composite layer having front and back faces and a window aligned with the display in the batteryless thin flexible display inlay, printing on the front face of the composite later and a transparent polyester plastic layer encapsulating the composite layer, the printing and the window. The composite layer comprises Teslin.

The present invention provides multiple features that are particularly advantageous in a number of different security applications. The architecture of the card contains all of the features needed to implement trustworthy security for all of its actions and protections for its contents.

One security feature of the invention is the electronic locking and unlocking mechanism for physical access to facilities and logical access to computer networks and databases. The security processor executes the cryptographic locking and unlocking process while the bi-state display provides data to the user about the state of the process.

Another security feature of the invention is it can act as a secure container for personal data, medical records, business data, passwords and keying material as well as other sensitive personal and business records, while it displays information needed to ensure the integrity of this data and its confidentiality.

Another security feature of the invention is the input output interface for the invention to reader utilities Near Field Communication (NFC) standards (ISO 14443) which provides high-speed bi-directional data transfers as well as providing power for the card components.

For this invention to be used in security applications, secure procedures are used for Identification and Authentication of users and establishing their privileges, Credentials or Authorizations. The invention implements a form of key management that uses the Secure ID Credential device to overlay security on the process for purposes of encryption.

The security and key management components of the present invention provide a means for a user to remotely and securely establish credentials of each participant in a communications link.

The security and key management components of this patent provide a means for a user to digitally sign and transmit documents in conjunction with the Secure ID Credential device.

In another embodiment, the present invention is a method to provide security protection for both the Private Key of the originator and a list of Public keys for all intended recipients the originator communicates with. This is achieved by means for securing the user's encryption keys with multiple layers of security built into the security processor, like anti-tamper sensors, random wait states between execution of program steps, internal clock oscillators, metal masking over memory, split encryption key algorithms and more.

The multi-layered security features and authentication process of this invention prevent other parties from viewing or modifications by anyone but the intended owner of the Secure ID Credential device.

Yet another feature of this invention is for remote validation of credential over a non-secure links. This opens many applications with significant security features. Completely secure remote access to a protected enclave, network or database is now a possibility, as are secure connections between co-workers holding similar credentials or access privileges.

Another preferred embodiment of this invention is as a card to remotely log into a secure enclave through a mobile device like a laptop, through the network, to a firewall. FIG. 10 illustrates a Display Card architecture for remote login.

Another security feature of the invention for remote login is a bi-directional two-way authentication process, meaning that the card and firewall hardware have the ability to first verify they are trusted devices respectively, prior to any information is decrypted and shared. This mutual Challenge Response authentication (FIG. 10 step 1) prevents the “leakage” of user data from a rogue reader, firewall, server or card. The display on the card is trusted and will show status of the mutual authentication process.

Yet another feature of the invention for remote login (FIG. 10, Step 2) binds the user to the card using a 2 or 3 factor authentication process. The third factor (biometric) is optional but would maximize the assurance level connecting the card to the user.

Another security feature of the invention for remote login is the display on the card will show status and results of each one of these authentication processes. Authentication can then allow for dynamic changes to the users level of access depending on threat level of the overall network, availability of biometric sensor, users location or privileges.

Another security feature of the invention for remote login is the integrated processor securely stores user's data like; digital photo, biometric templates, role, and privileges and vastly simplifies network database requirements. This data would be encrypted and only after a successful FIG. 10, Step 1 and Step 2 would the data be unlocked.

An additional feature of this invention is upon successful authentication, the session keys are decrypted and available for use between the card and the firewall as illustrated in FIG. 11 step 3. Again, the display could show access level, time-stamped access time, and data stored within internal memory.

Yet another feature of this invention is an independent audit log file of the secure session(s) (FIG. 11 step 4) can be displayed and carried on the user's token for later verification.

Another packaging technique and new assembly process is both low-temperature and low pressure not damaging the circuitry or segmented display. An encapsulating material is injected between two outside card layers using a flexible urethane elastomer material. The encapsulation becomes structurally integrated with the electrical components and smart windowing. This process call Reaction Assisted Injection Molding Process (RAMP), allows the delivery of gram-level quantities of reaction injection molding material reliably and accurately.

Since this alternative process is an “outside to inside” process it requires; a manufacturing process that is a low-temperature and low-pressure technology can over mold components at 50° C. and less than 25 psi (1.7 Bar), the “cold” process does not utilize high temperature to activate a bond of the core layer to the overlays, which helps eliminate damage to sensitive electronics, the urethane elastomeric material embeds materials to flow gaps as small as 0.0005″ with no out gassing which generate localize stress points, the Highly durable elastomeric core formulations further proved to be extremely, durable and almost impossible to remove without damage, and finally, Low viscosities, minimal injection forces, low shrinkage, and conducive to high-speed manufacturing.

The outside surface printing may comprise a wide variety of data, for example, a color photograph, personal information such as a birth date or identification number, employment information, access information or date information.

In another embodiment, the present invention is a method for authenticating a person using an authentication station having a biometric sensor, a display, and an RFID reader and a batteryless secure identification card having a bi-state display, a secure processor, a memory, an antenna and data printed data. The method comprises the steps of providing power to the batteryless secure identification card from the RFID reader, performing a verification algorithm on the secure processor to verify the card and the reader, performing a biometric scan of a person with the biometric sensor, performing a comparison of live biometric data from the biometric sensor with stored biometric data stored in the memory on the batteryless secure identification card, retrieving credentials associated with the person from the batteryless secure identification card in response to a positive comparison of the live biometric data with the stored biometric data, displaying the retrieved credentials on the display, inputting a positive comparison between the displayed credentials and the person, and writing confirmation data to the bi-state display in the batteryless secure identification card. The confirmation data comprise, for example, a date, job title, or code.

Other aspects of this invention are it provides the capability to dynamically change the segmented display after a successful authentication with a timestamp date, title/role, or other clearly visible text that the cardholder in-fact authenticated. An official or person could later visually check the display on the cardholder ID they successful authenticated with a pin number, biometrics or presenting their card to a verification station. This feature provides a secure “chain-of-trust” between the machine authentication station and a later human ID card verification. The card display proves to the verification official, the cardholder did successful verify earlier at the authentication station.

Other aspects of this invention are providing the ability to securely prevent only a trusted entity to write or change the card display. This is achieved by the secure processor that envokes encryption algorithms to insure user data cannot is secured when being transmitted from the reader to the card and to the card display.

Other aspects of the this invention include the integration of the bi-state display to the security processor. When applied, for example, to a mobile smart phone application, once the phone link (or internet connection) has been established, the Secure ID Credential cards will allow visual review using the secure display portion of the card, of the credential or authorization privileges of each of the participants by the other. Since the card display shows protected portions of the Secure ID Credential card memory, the memory contents are provably secure and a secure link has been established between the two cards, participants can now exam far end memory contents. Each user can assure himself of the access rights of the other user such that they can now exchange information that each has been authorized to access.

Other aspects of this invention include protection of the keys used for data transmission and securing the users data within the memory of the card. Encryption uses keys to encrypt this data however, this key has to be stored somewhere and the term, “Data-at-rest” emcompasses the complete security architecture implemented to secure the key or keys including how the authentication, tamper, and key split algorithms are used in concert.

Other aspects of this invention include built-in features with the security process to detect physical tampering or multiple attempts to access the key using an incorrect PIN. Any of these attacks will zeroize the key and render the badge and useless. Algorithms running on the security processor uses the cardholders 4-bit entered PIN to unlock a larger 1024-bit key. The data-at-rest would be protected with the 1024-bit key and it is impossible to attack by trying all possible keys, due to the fact that the number of key permutations grows exponentially when increasing key size.

Other aspects of this invention include active tamper protection. All signals switching the display have an active tamper boundary layer to secure these signals. A serpentine trace pattern designed surrounding the critical signals, which switch the display segments. This serpentine or rasterization pattern uses the minimum conductor (20 um width traces and 20 um spacing). If a “pin” probe were trying to reach the control signal lines, it would break the rasterization line. Before authentication the badge checks for a break by pulsing that signal and it will not authenticate if one is found.

Another aspect of this invention is the ability for the card and reader to cryptographically authenticate each other prior transferring data between each other by using the secure processor. The mutual authentication algorithm uses cryptographic algorithms running on software on the security process to insure both the card and the reader are trusted and verified. Once verified, the user credential data is decrypted on the card and sent to the reader. This methodology allows users more portability since users credentials are carried in the card, not in the access control database. Mutual authenication insures the ID holder is the correct and valid user, is authorized to release their credentials for identity, the ID credentials are genuine, unaltered, and not expired.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of the functional components of a smart display of secure ID credential in accordance with a preferred embodiment of the present invention.

FIG. 2A is a diagram of conventional static ID card.

FIG. 2B is a diagram of a secure ID credential having a smart display in accordance with a preferred embodiment of the present invention.

FIG. 3 is a diagram of a display assembly being placed into an ID card assembly in accordance with a preferred embodiment of the present invention.

FIG. 4 is a diagram illustrating the inductive coupling of power and two-way data to a mobile device like a cell phone.

FIG. 5 is a diagram of how passwords and biometrics are inputted, captured, and pre-processed prior to being forwarded to the card for final matching with a stored template.

FIGS. 6A and B are a flow chart illustrating a method for authentication of a secure ID credential in accordance with a preferred embodiment of the present invention.

FIG. 7 is a diagram illustrating various time-stamp and role-based information that can be displayed on a secure ID credential in accordance with the preferred embodiments of the present invention.

FIG. 8A and FIG. 8B show a five step process between the card and mobile device like a smart phone. FIGS. 8A and B describe the flow chart of user interface, and internal card operational steps to unlock and lock the mobile device.

FIG. 9 illustrates the key split architecture of the invention to provide Data-at-Rest security for the mobile device.

FIG. 10 describes the process to use the display card for remote access into a secure enclave.

### DETAILED DESCRIPTION OF THE PREFERRED EMBODIMENTS

A thin flexible display module can be encapsulated in protective plastic laminate to form a badge or ID credential. This new class of smart ID credential has a distinctive dynamic display feature provides particular benefits that enhance aviation security. These cards have advantages to other smart card credentials because they are:
Visually dynamic—the programmable bi-state can display day/hour/minute, verify a pilot in the cockpit, an airport employee, a Government official, a returning vet, or a pre-vetted passenger, for example.
Secure—performs as both an ID credential and secure “container” for personal information like boarding pass information, biometrics, name, birthday, or other flyer data.
Maintains both electronic and visual chain of trust—card can be verified at a kiosk or access control point, and then confirmed visually at a later time.

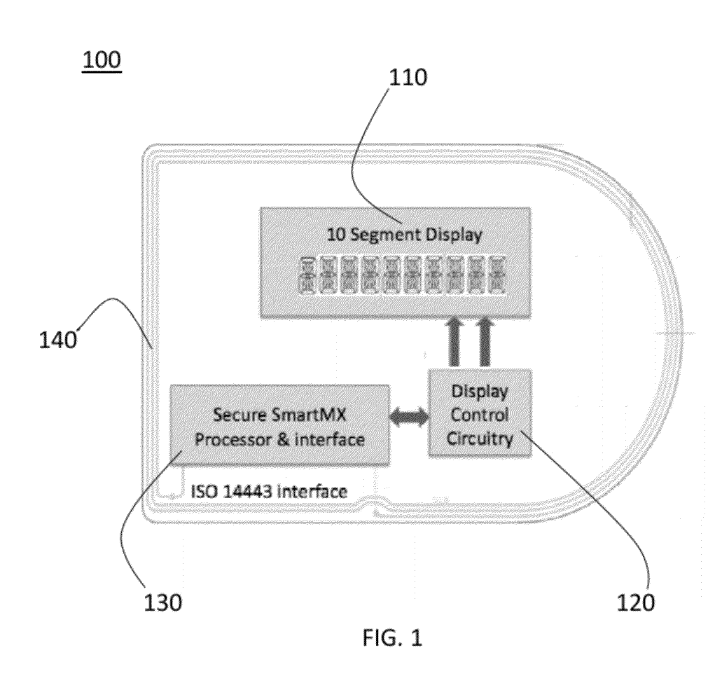

A thin flexible display assembly 100 has circuitry comprised of the functional components in FIG. 1. A bi-state display 110 is changed and update from power & data from the merchants RFID reader payment terminal. The display 110 will stay in the state it was written to until power and data are applied during the next payment or reward redemption transaction. Internal circuitry includes a secure processor 130 that interfaces with inlay antenna 140 and the special drive circuitry 120 for switching the bi-state display. The configuration of inlay components does not require an internal battery allowing the display assembly to operate for years. The near field communication (NFC) antenna 140 couples power and data electromagnetically from the coil of the reader. Based upon a modulation frequency of 13.45 MHz and using a standard baseband protocol defined as ISO 14443, a preferred embodiment of the invention was designed to work entirely through existing NFC RFID hardware. Internal chip memory encrypts and protects biometrics, user photo or biographical data, flight information, etc.

Public Key cryptography employs the concept of a Public-Private key pair that can be used for asymmetric encryption/decryption in which each of the keys is used for a different function. For encryption, the recipient's Public key (which has been widely distributed) is used to encrypt the holder's data for private transmission to the receiving entity who holds the matching Private key needed for decryption, and therefore is the only one the can do so.

In Public Key cryptography, there are two essential security elements, the first being that the Private key needs to be kept private, or secret. Revelation of this key would destroy the secrecy of the process. Likewise the Public key has restrictions. Even though it can and should be widely disseminated, its association with the owner of the key needs to be kept sacrosanct. Any substitution in this relationship, i.e., a malicious replacement of the recipient's Public key, again destroys the trustworthiness and security of the system and it would allow a third person, the one that owns the substitute Public key, to decrypt the document or message with his matching Private key. He could then re-encrypt using the original recipient's Public key who would then decrypt the message, thinking that the integrity of the message was intact, no had viewed it and that it was from the original sender. This is called the “man-in-the-middle” attack. This is also known as a “substitute phone book attack” and is a very serious problem that can be totally avoided if one can maintain the direct association between the intended recipient's name/address and his Public key by the person performing the original encryption.

Several systems are now being used to protect the relationship between the Public Key and the holder of this key, Public Key Infrastructure (PKI) being one. In this system, a Certificate Authority, a trusted third party, issues a certificate asserting this ownership relationship. PGP, a commercial product, performs this same function by utilizing a “web of trust”, one in which this relationship is protected by referring trusted associates.

Both of these systems are targeted towards large implementations and suffer from an excessive amount of overhead. Conversely, the system being proposed here is one that is simple, intuitive and is based on the use of the Secure Credential ID card for implementation. It is however, intended for applications with somewhat limited user populations.

This invention proposes to make use of the Secure ID Credential card to provide protection for both the Private Key of the originator and a list of Public keys for all intended recipients. This is possible because of the security of the card itself. Since the memory that contains these keys is protected by the security processor, they are not available for viewing or modifications by anyone but the intended owner of the Secure ID Credential card because of its secure authentication process. This means that the list of Public keys and associated owners can be maintained without fear of modifications.

The list of Public keys and associated names/addresses/phone numbers can be added to or modified at will by the owner of the card, in keeping with him being assured that the required associations are correct. In fact, the source of these modifications could be a Public Key Infrastructure or a PGP network but more likely would originate with the manager of the network of participants.

The advantages in using this scheme rather than a full PKI structures for this key protection process are that it is simpler to maintain for a small community of users and that there is no need to maintain an on-line contact with a centralized Certificate Authority as long as the list is set correctly initially. But it should be noted that the “phone book” should be regularly maintained in that erroneous or compromised numbers (with the associated Public keys) should be removed as soon as possible in that they represent potential compromises to the system. This can be done via an administrative procedure set up most likely by the manager of the network.

The applications for this invention are numerous but would be normally limited to small groups of participants. An ideal scenario would be one in which each Secure ID Credential card would be initialized with a common phone book at the same time. Phone or document distribution networks would natural applications.

A Smartphone network in which the encryption is embedded into the phone would be amenable to the use of this Secure ID Credential key management process. To initiate a call, the first step would be to unlock the phone with the Card through an authentication and initialization process. The user would then select the intended called party from the phone list, the associated Public key would be provided to the phone to be used in establishing the secure link. The Private key held by the recipient' Secure ID Credential card would also be used by the receiving phone to complete the link establishment.

Once the phone link (or internet connection) has been established, the Secure ID Credential cards will allow visual review using the secure display portion of the card, of the credential or authorization privileges of each of the participants by the other. Since the card display shows protected portions of the Secure ID Credential card memory, the memory contents are provably secure and a secure link has been established between the two cards, participants can now exam far end memory contents. Each user can assure himself of the access rights of the other user such that they can now exchange information that each has been authorized to access.

This same key pair can also be used for digitally signing documents. When the holder uses his Private key to encrypt his document, this action provides a signature asserting that he believes this information to be true. The recipient then decrypts the document with the originator's Public key (as part of the “phone list” previously stored in his own Secure ID Credential card secure memory). This then provides assurance that the originator is who he says he is and that he stands behind the data, in that he (the originator) holds the matching Private encryption key.

Keys are an essential part of all encryption schemes. Their management is a critical element of any cryptographic-based security. The true effectiveness of key management with mobile devices like cell phone, laptop, & tablets are eliminates the requirement for special purpose hardware within the mobile device. This patent meets this requirement by placing the special purpose hardware for combining keys within the card and not the mobile device.

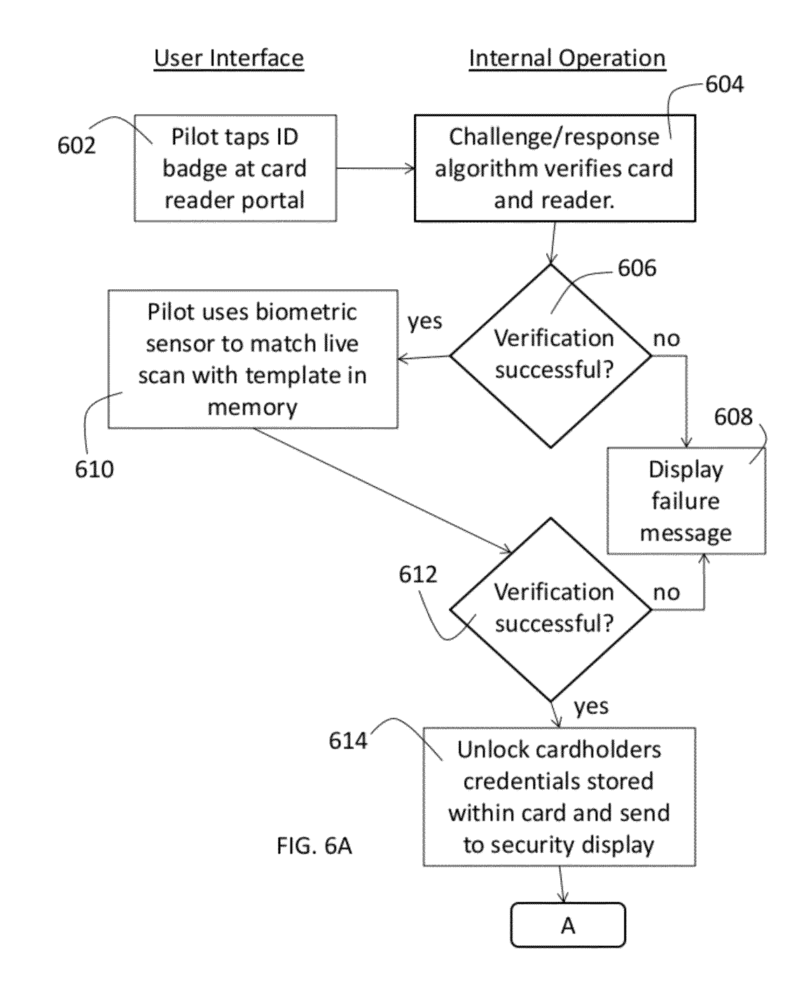

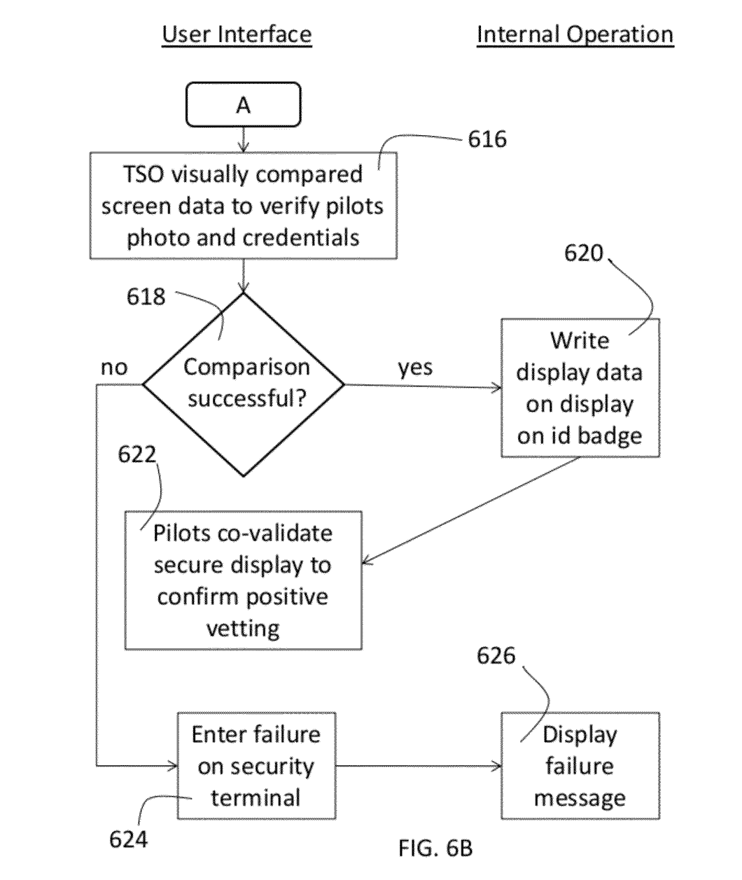

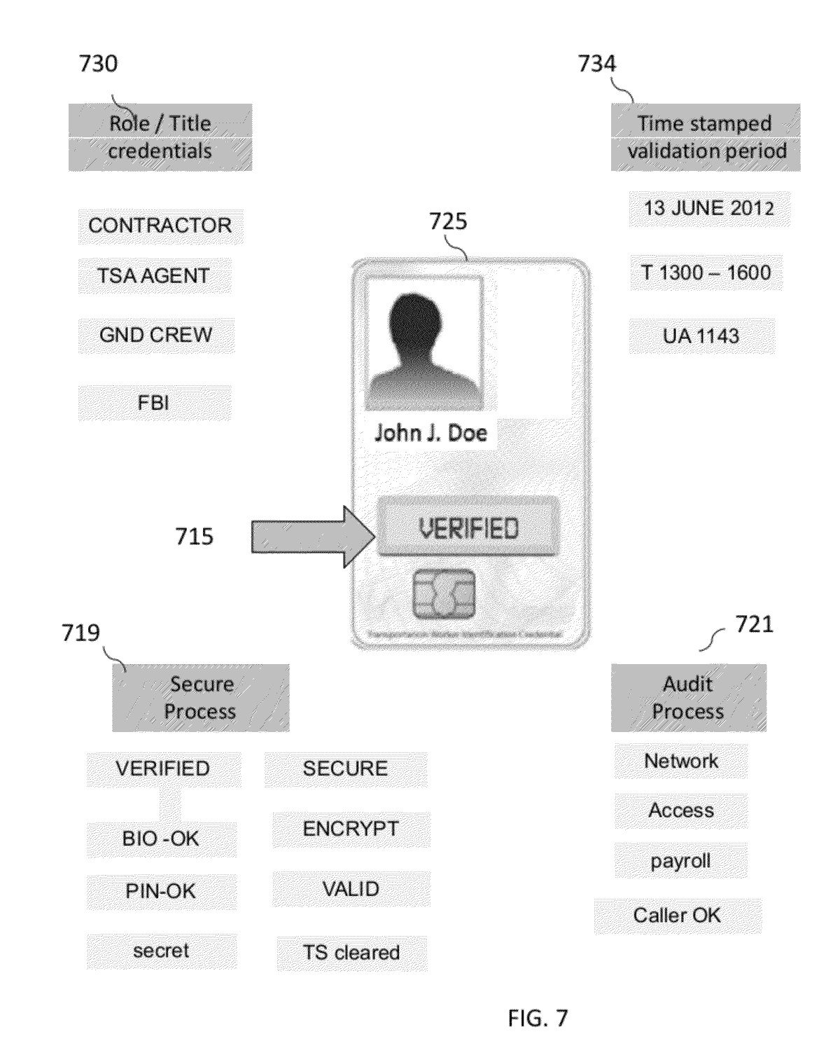

FIG. 6 is a flowchart describing the method for generating and regenerating unlocking decryption key for the mobile devices. The mobile device can be a smart phone, laptop, tablet, access control portal, PC, kiosk or any other device. Note that all generation is done within the card rather then the mobile device. The working key (decryption key) is built from keys splits from the mobile device, display card device, and one split from the user a password that is cryptographically expanded.

To be a participant in the system, a user must have the pieces necessary to build the key; otherwise encryption and decryption cannot take place. A central authority generates these pieces the first when issuing a new user in the network. These keys are called cryptographic key splits. The cardholder keys, password, and biometric templates are downloaded into the secure memory of their display card processor when issued a card by the central authority.

To build a decryption key, the three key splits are combined with a unique number like a date that is used as the basis for the session key.

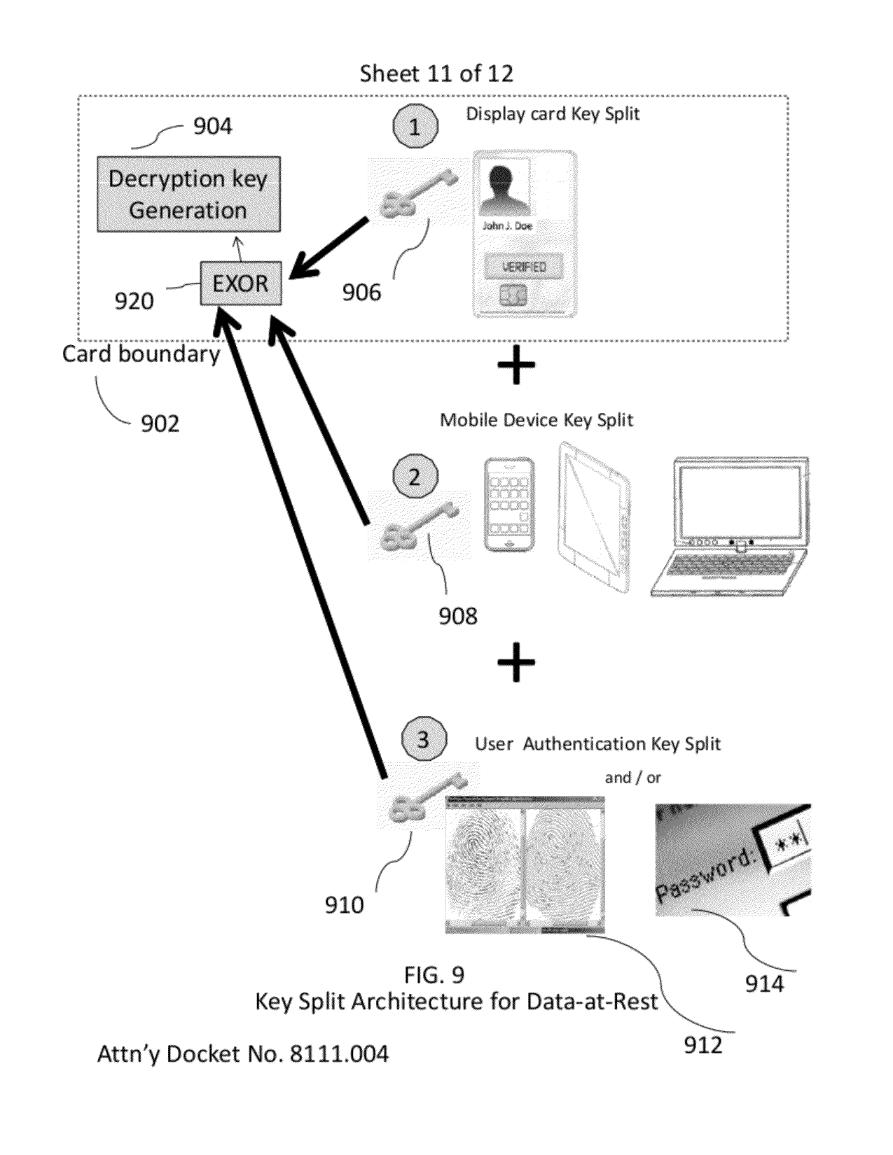

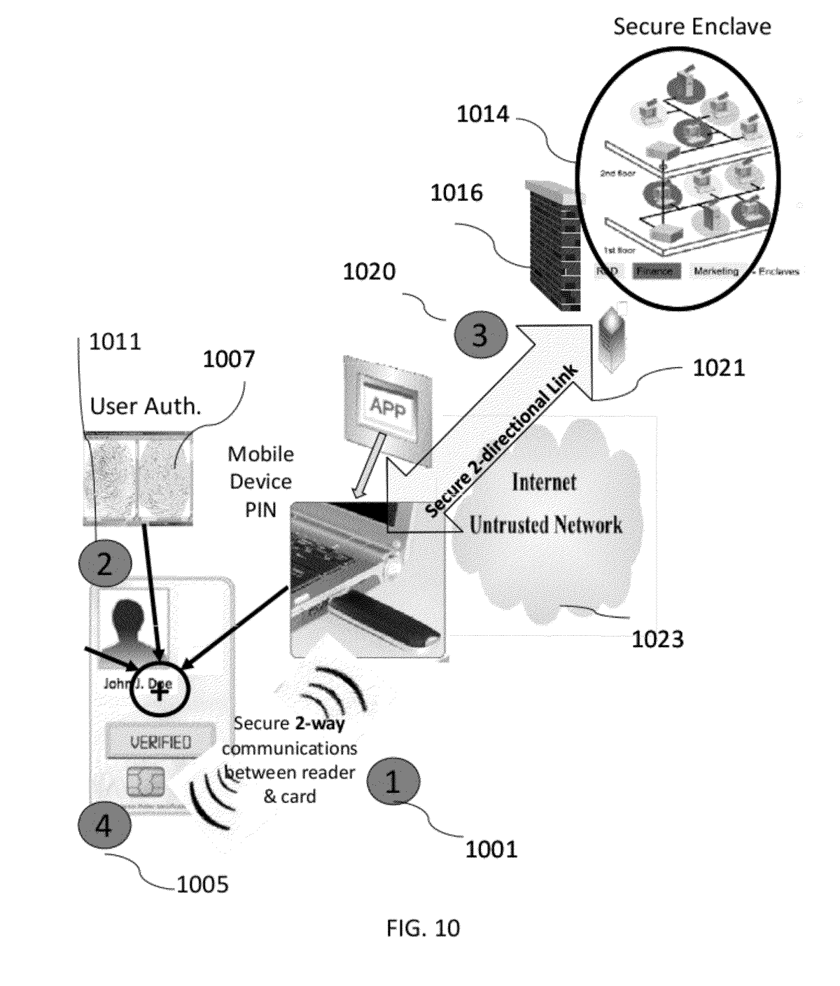

To bind the users to the card, a password and/or biometrics are used. FIG. 9 show the key split architecture required to unlock and lock the mobile device. The card technology contactless interface designed to communicate with standard commercial readers with NFC (Near Field communication). NFC is now ubiquitous in many networks like retail POS, laptop computer, banking, transportation and newer smart phones. It is for these reasons the inventions interaction with the mobile device is more simplistic to scale with smartphones, tablets, and laptops rather than placing these features as custom hardware in the mobile devices.

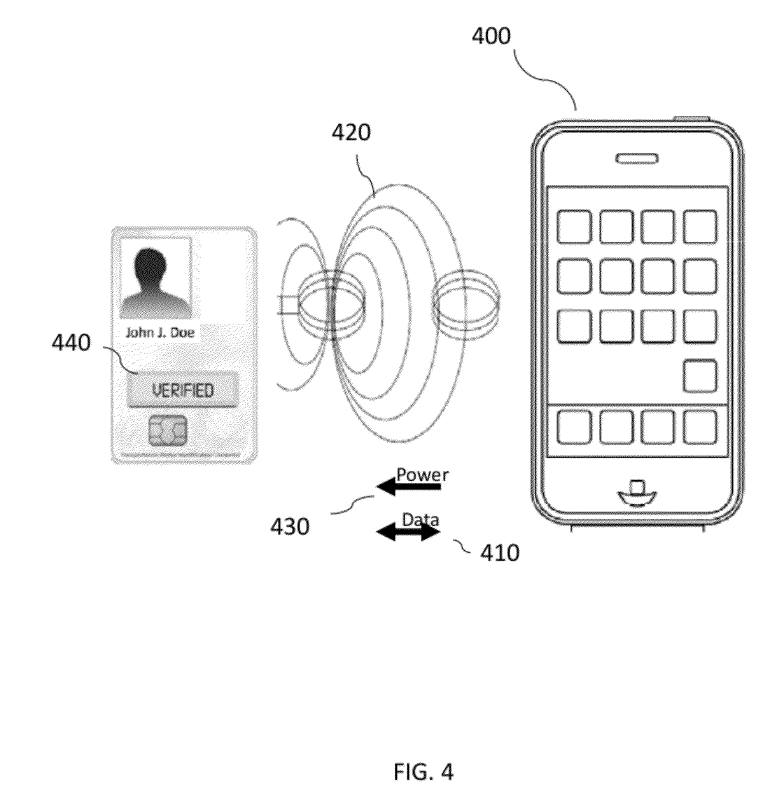

Another feature of the invention is the security circuitry is designed to be 100% powered and parasitic to the reader. Since all power and data I/O is coupled into the system inductively from the reader when the card is brought within an inch of the reader, the solution provides unlimited life of the card. (see FIG. 4)

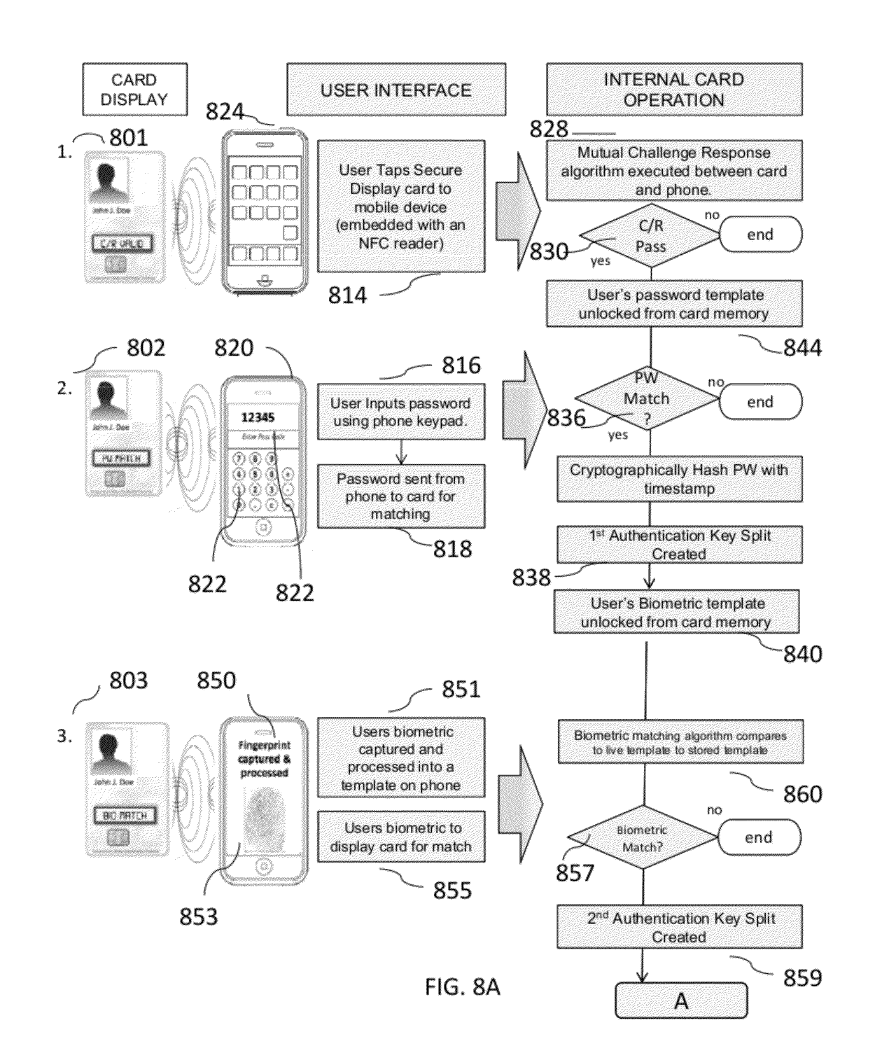

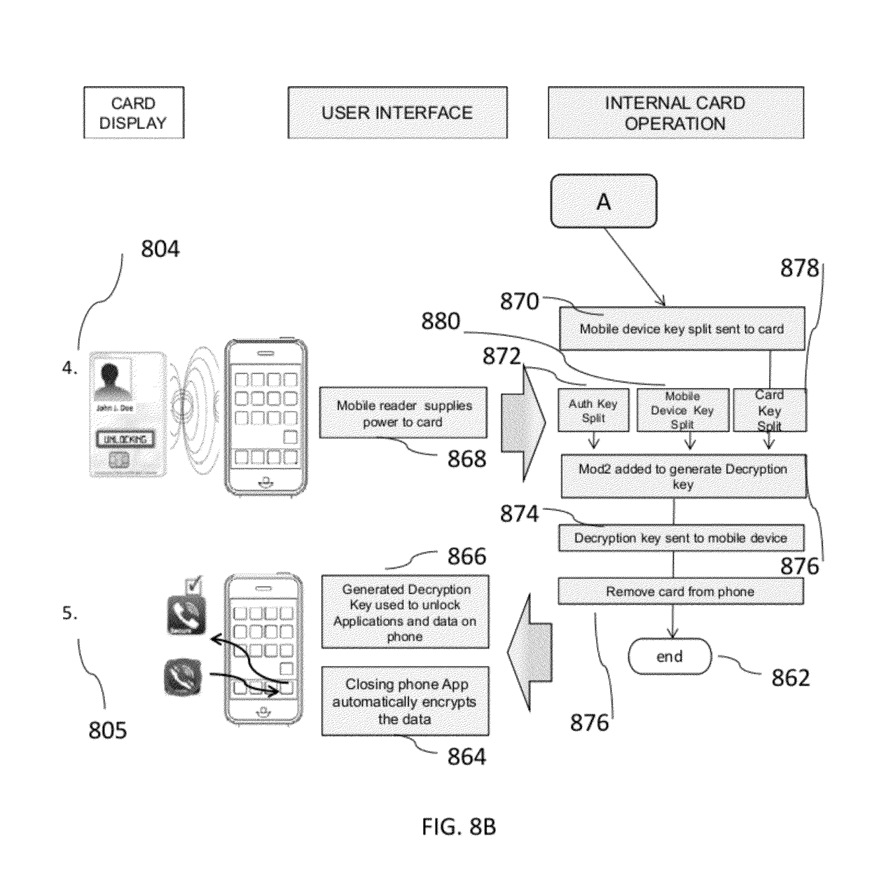

In the secure ID credential with a mobile phone of the present invention, as shown in FIG. 8, binds the user to the card and cryptographically unlocks the mobile phone or the secure application running on the phone. In the locked state, a potential adversary cannot extract the user's stored data or key since essential information, the encryption key, is split between the phone and the display card. Activation only occurs when the card is brought into close proximity to the phone and the user authenticates him self to the card.

The invention includes a security processor, memory, display and other security hardware to execute the Unlock/lock mechanism for the mobile device. If similar circuitry were place within the phone, cost would be considerably more expensive and would still require secure storage of user's biographical, biometrical, and cryptographic key data on the card to provide data at rest.

The invention includes the security processing capability to match the Password and biometric templates entirely in the boundary of the card. FIG. 9. Additional the user's biometric template, password template, and private keys never leave the card which could expose and compromise can expose the user's data to loss or modification by potential hackers. Matching passwords and biometric outside the card would require more secure readers, central databases, and the link between them.

In the Secure ID credential of the present invention architecture interacting with a mobile device for a crypto enabling key is vastly different then traditional ID card See FIG. 8A and FIG. 8B. First, the ID card combines the minimal set of security components to encrypt the user's credentials and biometrics within their card. Second, when presenting their credentials to any mobile device, the reader and card cryptographically authenticate each other, before authenticating the cardholder via password and biometrics.

The step-by-step description of the process to Unlock and lock a mobile device like a smart phone using the display card invention is shown in FIG. 8A and FIG. 8B and described below:

1. Inductively power-up the card through the RFID reader build into the commercial smart phone.

2. The card and phone would do a cryptographic Challenge/Response—result would decrypt the password and/or biometric data within the card.

3. User inputs password into the phone keypad, this is sent to the card which Hashes it 5 times generating a 160 bit key split (which will be used later).

4. A commercial biometric reader and matching software running on the phone will take a live scan of the users print, pre-process it down into a minutia map and forward it to the display card for a final comparison with the stored minutia template. Note the template never leaves the card. The display on the card shows if the bio match was successful or failed.

5. The 160 bit stored within the phone is forwarded to the card and confirmed by the SDC card display.

6. Three key splits are combined within the display card; the 160-bit display key, the 160 bit phone key split, and a key split generated by the password hash. These three keys plus a positive biometric match, generate a session key, which is used to decrypt the software application the cardholder would like to use on the phone.

7. The session key could also decrypt files, other keys for the month, etc

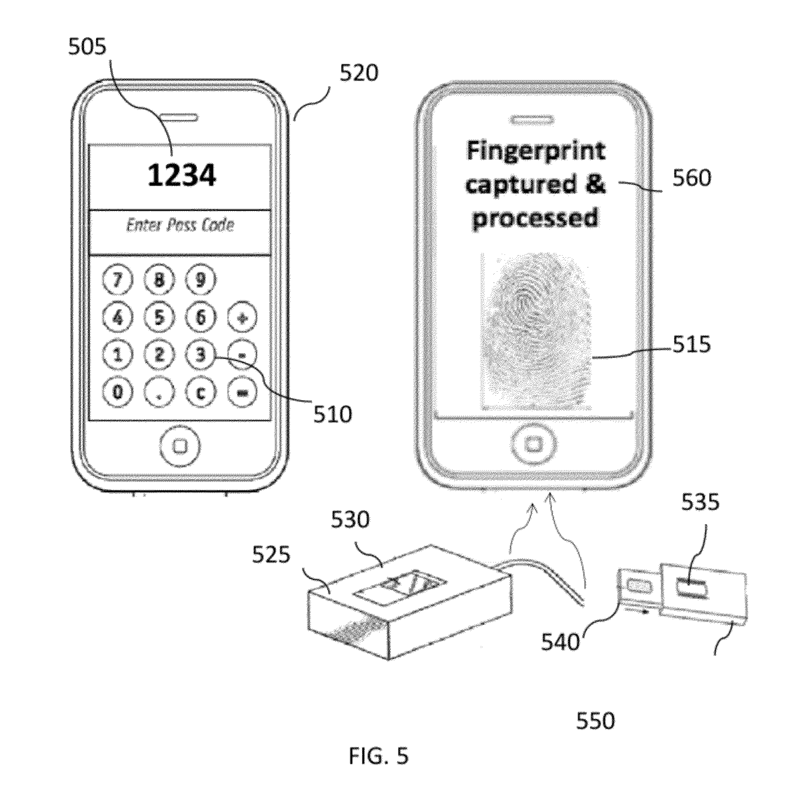

FIG. 5. Notes this inventions architecture does not integrate the specific biometric scanner into the token, rather the focus was to employ just enough secure processing capability within the card to execute the final biometric match with the template. In parallel, an ON-CARD display shows the pending processes and results.

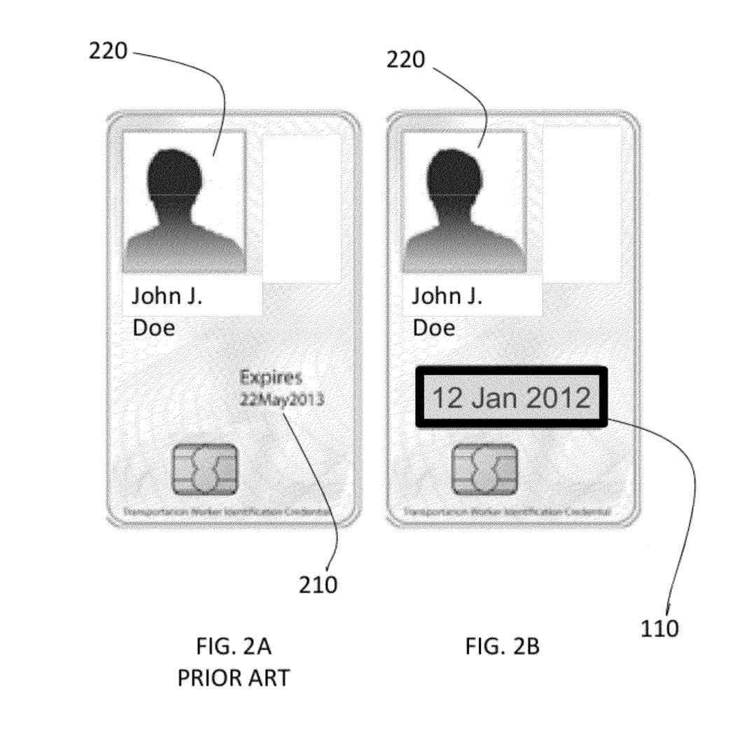

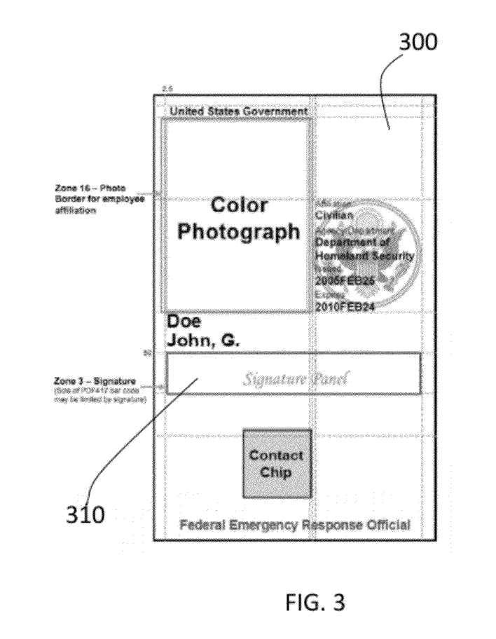

In the Secure ID credential of the present invention, as shown in FIG. 2B, the display circuitry or assembly is fully encapsulated in a composite layer of Teslin™, and then a polyester plastic. The outer surface of the Teslin is printed using a digital, reverse dye sublimation, heat transfer, or any traditional ink process to create the graphics or print on the Teslin. The area were the display is located is cut out in the Teslin. The inlay is attached from the inside and aligned with the cut-out window. The Telsin layer provides excellent thermal barrier from excessive hot & cold temperatures.

The polyester layer serves two functions. First, it provides a transparent or clear protective window on top of the display panel area. Second, it acts a general protective barrier for the circuit display inlay from water and chemicals.

The present invention places more capability, trust, security, and computation in the card that conventional systems. One output of the present invention is writing the result of the access control process to a display located within the card. The output indicates a timestamp, user role, or date the access control event occurred making it a dynamic credential. Existing conventional cards are visually static since the picture and other data like expiration dates do not change on the card. FIGS. 2A and 2B show a comparison of a conventional static card versus the dynamic display card of a preferred embodiment of the present invention. In the conventional card of FIG. 2A, all of the information, such as picture 220 and expiration date 210 are static. In the card of a preferred embodiment of the present invention, the picture 220 remains static but the expiration date 110 is dynamic.

Storing the data in the card and having on-card display increase the effectiveness and simplifies the authentication network. In addition, mobile access stations do not require secure connectivity back to a central database that stores each user's data.

Integrating a dynamic display on the ID card allows cardholder to for example, authenticate at one location maybe not at the perimeter of the secure facility. The checking agent could simply visually check the card holder's display proving they recently validated at an access control station. The display would show the days, weeks, months the cardholder's card was valid. The dynamic secure display technology embedded into the card provides a chain of trust to the authentication process. This invention bridges the security air gap between checkpoints, to maintain chain of trust.

The comprehensive solution requires a more capable credential that can securely store the user's biometric and other data, and visually prove at a later time that a secure authentication process at the access control terminal has successfully been performed.

The method of a preferred embodiment of the present invention, shown in FIGS. 4A and 4B, demonstrates how the secure display card of the present invention would operate for aviation application for aircrew when there is a requirement for a chain of trust network between the access control station and the aircraft. With full cryptographic functionality within the card is interoperable between airports and does not mandate a central database to upload the user's biometric and biographical data for authentication. Pilot's data can be stored securely within the card and data can be checked for integrity by matching the digital signature of this data.

Since a trusted authentication access control station is the sole entity to modify the display and official, the “expiration date” shown on the card display provides visual proof the pilot recently authenticated. The process begins at the trusted authentication access control station with a pilot or other airline crew member tapping their secure ID badge or credential to a reader at the station at step 402. Once the card is tapped at the reader, the challenge/response algorithm in the card verifies the card and the reader at step 404. If the verification fails at step 406, a failure message is displayed on the card at step 408 to show that an unsuccessful attempt was made to authenticate the card. In other embodiments, the card could be disabled after one or several unsuccessful authentication attempts. If the verification is successful, the pilot uses a biometric sensor at the authentication station at step 410. The biometric sensor may be of any known type, for example, a finger print scanner, iris scanner, or camera for facial image recognition. The live biometric data taken at the verification station is compared to biometric data securely stored on the ID badge or credential at step 412. If verification fails, a failure message is again displayed at step 408. If the verification is successful, at step 414 the cardholder's credentials stored within the card are unlocked and sent to the security station where they may be displayed. The TSO or security officer then visually compares the screen data such as the crew member's photo and credentials to the crew member at step 416. If the comparison is unsuccessful at step 418, the TSO enters a failure at the security terminal and a failure message is displayed on the ID card or badge. If the comparison is successful at step 418, display data is written on the ID display at step 420. At that point, the crew member may proceed through security to the plane. If the crew member, for example, is a pilot, to positively validate the jump seat pilot, the chief pilot needs only to visually check the time and date displayed on the card. This confirms to the chief pilot the cardholder verified biometrically and cryptographically earlier at the access control terminal.

The display is written via the RFID interface from the access terminal reader. The access terminal is assumed secure and trusted therefore all display information is done through the payment software. Audible tones to mark completion of the process, is done by the payment terminal.

The display examples to the right show a few possible options the terminal could right to the display. Overall there are two categories of messages;
Time-Stamped messages—shows the time, date, week, month the user authenticated through an access portal. This value is set by the network dependent upon the user's privileges. For example, if the user was on a ship sailing across the Atlantic, they might have access for one month.
Role messages—The user may be a First Responder who has access to various areas of a building and under an emergency, these access may increase.
   The example in FIG. 5 shows the variety of time-stamped and role based labels that could be displayed on the card.

The display may be a segmented electrophoretic display (E ink), which does not require any power to keep its visible information. The display, for example, contains 10 digits alpha-numerics. The software at the secure controller can drive the display through a supplied SW library.

The display may be, for example, an electrophoretic layer or assembly comprised of a backplane, a top plane, and an electrophoretic material positioned in between the two. In a preferred embodiment, the bottom plane is an electrical circuit layer and the top plane is a transparent conductive plastic layer. In a preferred embodiment, the display is an E-Ink bistable display based on electrostatic charges used to affect tiny spheres suspended in a plane. The spheres are electrostatically charged with a black half carrying the negative charge and a white half carrying the positive charge. Two electrodes surround the plane; the front one transparent. When a charge is placed across the electrodes the spheres rotate to align with the front-to-back charge gradient. Because the spheres are suspended in a semi-solid when the power is removed, they remain in that position and the display continues to show whatever design or text it showed before power was removed.

In another embodiment, an SiPix display is used. The SiPix display is a variant of a plastic Electrophoretic display that is thin and flexible and uses a microcup structure to hold electronic ink stable. SiPix's microcup technology involves a microscale container which holds minute quantities of fluid and particles.

The display structure, typically 150 μm thin, is built upon a flexible PET plastic substrate, which may include a transparent conductor such as Indium Tin Oxide (ITO). The contents of the microcup are hermitically sealed by sealing layer to protect them from the environment. Similar electrodes on both either side change position and orientation of material suspending in a gel like fluid. SiPix is also an Electrophoretic a reflective display that uses electrophoresis to switch pixels or segments on and off. Electrophoresis is the motion of charged particles suspended in a liquid in response to an electric field. If the white particles migrate to the visible surface, the display exhibits the color white.

In yet another embodiment, the bi-state display is a spiral crystal LCD technology that reflects almost all the image light cast on it while attenuating most of the ambient light to produce a bright reflected display. Cholesteric materials are liquid crystal that is a type of liquid crystal with a helical (smooth curve like a spiral) structure. Cholesteric liquid crystals are also known as chiral nematic liquid crystals have molecules that maintain their orientation. Some substances exist in an odd state that is similar to both liquid and solid. When they are in this state, the molecules tend to maintain their orientation, like solids, but can also move like a liquid. Liquid crystals are such materials. However, in essence they are more like a liquid and require only a little heat to move from this odd state to a liquid state. A feature of liquid crystals is that they are affected by electric currents. Depending on the temperature and particular nature of a substance, liquid crystals can be in one of several distinct phases, including nematic phase and the cholesteric phase. LCDs use these types of crystals because they react predictably to electric current in such a way as to control light passage.

In still another embodiment, an electrochromic display is used. The display is comprised of a layer of electrochromic material sandwiched between two electrode layers. The material changes from one color to another when stimulated by an electric current. The top electrode layer is made from transparent plastic, so the display can be seen clearly through it.

The chemical reaction at work is an oxidation reaction—a reaction in which molecules in a compound lose an electron. Ions in the sandwiched electrochromic layer are what allow it to change from opaque to transparent. It's these ions that allow it to absorb light. A power source is wired to the two conducting oxide layers, and a voltage drives the ions from the ion storage layer, through the ion conducting layer and into the electrochromic layer. This makes the glass opaque. By shutting off the voltage, the ions are driven out of the electrochromic layers and into the ion storage layer. When the ions leave the electrochromic layer, the window regains its transparency.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A secure identification card comprising:
a batteryless thin flexible display inlay comprising:
a bi-state display;
display control circuitry;
a secure processor; and
an antenna;
a housing encapsulating said batteryless thin flexible display inlay, said housing comprising:
a composite layer having front and back faces and a window aligned with said display in said batteryless thin flexible display inlay;
printing on said front face of said composite later; and
a transparent polyester plastic layer encapsulating said composite layer, said printing and said window.

2. A secure identification card according to claim 1 wherein said composite layer comprises Teslin.

3. A secure identification card according to claim 1 wherein said printing comprises a color photograph.

4. A method for authenticating a person using an authentication station having a biometric sensor, a display, and an RFID reader and a batteryless secure identification card having a bi-state display, a secure processor, a memory, an antenna and data printed data, the method comprising the steps of:
providing power to said batteryless secure identification card from said RFID reader;
performing a verification algorithm on said secure processor to verify said card and said reader;
performing a biometric scan of a person with said biometric sensor;
performing a comparison of live biometric data from said biometric sensor with stored biometric data stored in said memory on said batteryless secure identification card;
retrieving credentials associated with said person from said batteryless secure identification card in response to a positive comparison of said live biometric data with said stored biometric data;
displaying said retrieved credentials on said display;
inputting a positive comparison between said displayed credentials and said person; and
writing confirmation data to said bi-state display in said batteryless secure identification card.

5. The method for authenticating a person according to claim 4, wherein said confirmation data comprising a data.
